(19) United States
(12) Patent Application Publication
(10) Pub. No.: US 2024/0412462 A1
(43) Pub. Date: Dec. 12, 2024

(54) VIDEO MANIPULATION COMPUTER PROGRAM AND VIDEO COMMUNICATION SYSTEM

(71) Applicant: WEAR2MEET OY, Helsinki (FI)

(72) Inventor: Vesa SILASKIVI, Helsinki (FI)

(21) Appl. No.: 18/702,009

(22) PCT Filed: Oct. 21, 2022
(86) PCT No.: PCT/FI2022/050700

§ 371 Date: Apr. 17, 2024

(30) Foreign Application Priority Data
Oct. 22, 2021 (FI) 20216098

(51) Int. Cl. G06T 19/00; G06V 20/40; G06V 40/10

(52) U.S. Cl. CPC G06T 19/00; G06V 20/41; G06V 20/49; G06V 40/10; G06T 2210/16

(57) ABSTRACT

A video manipulation computer program including instructions which, when executed by at least one processor of a user device cause the user device to perform manipulating of an input video stream provided by an imaging device of the user device. The manipulation computer program is configured to capture the input video stream of the imaging device, provide the captured input video stream as input video data to the manipulation computer program, detect a person as a body item in the input video data, fit a wearable video item on the body item in the input video data to provide manipulated video data, and output the manipulated video data as manipulated video stream from the manipulation computer program.

### FIELD OF THE INVENTION

The present invention relates to video manipulation computer program and more particularly to a video manipulation computer program according to preamble of claim 1. The present invention also relates to video communication system and more particularly to a video communication system according to preamble of claim 20.

### BACKGROUND OF THE INVENTION

In the prior art video communication computer programs, a video stream is generated with an imaging device of a user device or with a imaging device connected to the user device. The imaging device is usually a digital camera integrated to the user device or a web camera connected to the user device. The video communication computer program, meaning a video conference computer program broadcasts a video stream from the user device to one or more other user devices over communication network during a video conference session and this video stream is displayed on the displays of the one or more other user devices. In the prior art video communication computer programs, there are features allowing the user to provide effects to the video stream broadcasted from the communication computer program over the communication network by adding filter to the video stream. These filters enable to user to remove, change or blur the background in the video stream. These features vary from one communication program to another.

One of the problems associated with the prior art is that the video communication computer programs do not allow the user to personalize the video stream and especially personalize the user itself in the broadcasted video stream. Each communication computer program comprises different features to add filters to the video stream such that the user cannot personalize the user itself in a consistent and similar manner when using several different video communication computer programs. The user is only able personalize the video stream with effects provided in the communication computer program.

### BRIEF DESCRIPTION OF THE INVENTION

An object of the present invention is to provide a video manipulation computer program and a video communication system such that the prior art disadvantages are solved or at least alleviated.

The objects of the invention are achieved by a video manipulation computer program which is characterized by what is stated in the independent claim 1. The objects of the invention are also achieved by a video communication system which is characterized by what is stated in the independent claim 20.

The preferred embodiments of the invention are disclosed in the dependent claims.

The invention is based on the idea of providing a video manipulation computer program comprising instructions which, when executed on at least one processor of user device cause the user device to perform manipulating of an input video stream provided by an imaging device of the user device.

The manipulation computer program is configured to
capture the input video stream of the imaging device;
provide the captured input video stream as input video data to the manipulation computer program;
detect a person as a body item in the input video data, the body item representing the person in the input video data;
fit a wearable video item on the body item in the input video data to provide manipulated video data; and
output the manipulated video data as manipulated video stream from the manipulation computer program.

Accordingly, the video manipulation computer program is configured to receive the input video stream generated by the imaging device directly from the imaging device. Therefore, the input video stream is the original video stream of the imaging device without any modifications. The video manipulation computer program is therefore configured to manipulate the original video stream of the imaging device by fitting the wearable video item on the body item. Thus, the manipulated video stream of the original video stream is outputted from the video manipulation computer program to be used in the user device or in a computer program running in the user device.

In the present application the term body item means a body of person in video data and image data. Video and image data represent data generated by a digital imaging device and an image senor thereof.

Further, in the present application a body party item means for example head, torso, lower body, hand(s) or leg(s) of the body of the person in the video data or image data.

In general, video data and image data comprise two or more separate digital images or image files. Video data comprises two or more image frames or image frame files each of which is a separate digital image.

In the present application the term wearable video item means an image object representing digital image representation of an object which is worn by a person on the body of the person. The wearable video item may be garment, hat, eyeglasses, scarf, shirt, jacket, trousers, skirt, or shoes or the like wearable video item which is fitted on the body item or a body part item in the input video data.

The wearable video item is separate image item or object representing the wearable image item. The wearable image item may be two-dimensional or three-dimensional image item or object.

An item in the video data, video stream or image data in digital images or digital videos means an object which is an identifiable portion of a digital image and may be interpreted or identified as a single unit. In the present application, the body item, the body part item and the wearable video item are objects which are identifiable units in the video data.

In preferable embodiments, the video manipulation computer program is configured to register the manipulated video stream to an operating system of the user device as virtual imaging device.

Registering the manipulated video stream to the operating system of the user device as a virtual imaging device enables computer programs and software applications running in the user device to utilize the manipulated video stream as input video stream similarly as the original video stream directly from the imaging device. Thus, the manipulated video stream is configured to be utilized by any computer program or application running in the user device.

In some embodiments, the imaging device comprises an image sensor configured to generate the input video stream, and the manipulation computer program is configured to capture input video stream generated by the image sensor.

Accordingly, the video manipulation computer program is configured to receive the input video stream directly from the image sensor of a digital imaging device.

In some other embodiments, the imaging device comprises an image sensor configured to generate the input video stream, and to provide the input video stream to the output of the imaging device, and the manipulation computer program is configured to capture input video stream from the output of the imaging device.

Accordingly, the video manipulation computer program is configured to receive the input video stream directly from the output of a digital imaging device.

In some embodiments, the video manipulation computer program is configured to identify a first body part item in the detected body item in the input video data, the first body part item representing one body part of the person and fit the wearable video item on the identified first body item in the input video data to provide the manipulated video data.

Accordingly, the video manipulation computer program is configured to identify for example head, torso, lower body, hand(s) or leg(s) of the person in the input video data.

In some embodiments, the video manipulation computer program is configured to remove background image item from the input video data, the background image item comprising image data outside the body item, fit the wearable video item on the detected body item, and combine the removed background image item and the body item having the wearable video item to provide the manipulated video data having the wearable video item on the body item.

Removing the background outside the body item enables detailed and more efficient identification of the body item and more detailed fitting of the wearable video item on the body item.

In some other embodiments, the video manipulation computer program is configured to remove background image item from the input video data, the background image item comprising image data outside the identified first body part item, fit the wearable video item on the identified first body item, and combine the removed background image item and the first body part item having the wearable video item to provide the manipulated video data having the wearable video item on the first body part item.

Removing the background outside the first body part item enables detailed and more efficient identification of the specific first body part item and more detailed fitting of the wearable video item on the specific first body part item.

In some further embodiments, the video manipulation computer program is configured to remove background image item from the input video data, the background image item comprising image data outside the body item, separating the first body part item from the body item, fit the wearable video item on the separated first body part item, combine the first body part item to the body item, and combine the removed background image item and the body item having the wearable video item to provide the manipulated video data having the wearable video item on the first body part item.

Removing the background and separating the first body part item from the body item enables fitting of the wearable video item on the specific first body part item in great detail.

In some embodiments, the video manipulation computer program is configured to split the input video data into a body item layer and a background layer, the body part layer comprising the detected body item and the background layer comprising image data outside the detected body item, fit the wearable video item on the detected body item in the body item layer, and combine the background layer and the body item layer to provide the manipulated video data having the wearable video item on the body item.

Splitting the input video data into the body item layer and the background layer, provides simple and efficient removal of the background and fitting of the wearable video item on the body item in the body item layer.

In some other embodiments, the video manipulation computer program is configured to split the input video data into a first body part item layer and a background layer, the first body part item layer comprising the identified first body part item and the background layer comprising image data outside the identified first body part item, fit the wearable video item on the identified first body item in the first body part item layer, combine the background layer and the first body part item layer to provide the manipulated video data having the wearable video item on the first body part item.

Splitting the input video data into the first body item layer and the background layer, provides simple and efficient removal of the background and fitting of the wearable video item on the specific first body item in the first body part item layer.

In some further embodiments, the video manipulation computer program is configured to split the input video data into a body item layer and a background layer, the body item layer comprising the detected body item and the background layer comprising image data outside the detected body item, split the body item layer into a first body part item layer and a second body item layer, the first body item layer comprising the identified first body part item and the second body item layer comprising body item outside the identified first body part item, fit the wearable video item on the identified first body part item in the first body part item layer, and combine first body part item layer, the second body item layer and the background layer to provide the manipulated video data having the wearable video item on the first body part item.

Splitting the input video data into the first body part item layer, the second body item layer and the background layer, provides even more simple and efficient removal of the background and fitting of the wearable video item on the specific first body part item in the first body part item layer.

In some embodiments, the video manipulation computer program is configured to provide an object detection algorithm trained to detect body item in image data, utilize the input video data as input data into the object detection algorithm for detecting the body item in the input video data, and fit the wearable video item on the detected body item in the input video data to provide the manipulated video data having the wearable video item on the body item.

The object detection algorithm is configured to detect features, such as edges, of the body item. Then the wearable video item is fitted on the body item based on the detected features, such as edges, of the body item. This provides fast fitting without separation of background or image layers.

In some other embodiments, the video manipulation computer program is configured to provide an object detection algorithm trained to detect body item in image data and identify one or more body part items in the detected body item, utilize the input video data as input data into the object detection algorithm for identifying the first body part item in the input video data, and fit the wearable video item on the identified first body part item in the input video data to provide the manipulated video data having the wearable video item on the first body part item.

The object detection algorithm is configured to detect features, such as edges, of the first body part item. Then the wearable video item is fitted on the first body part item based on the detected features, such as edges, of the first body part item. This provides fast fitting without separation of background or image layers. Furthermore, the first body part item needs not be separated from the body item or the body item does not need to be split into first body part item and second body item.

The object detection algorithm may be any known algorithm capable of and trained to detect and identify body item or first body part items in image data. Accordingly, the object detection algorithm is be configured to detect and identify body item and body part items in the input video data. Training an object detection algorithm is generally known, and carried out by utilizing image data with body items and body part items.

The object detection and/or identification algorithms may be based on neural networks. Examples of specific algorithms comprise Faster R-CNN (Region Based Convolutional Neural Network), YOLO (You Only Look Once), SSD (Single Shot MultiBox Detector) and R-FCN (Region-based Fully Convolutional Networks). Also other suitable algorithms for object detection may be used witing the scope of the present invention.

In some embodiments, the video manipulation computer program is configured to maintain a wearable video item database having one or more wearable video item profiles, each of the wearable video item profiles comprising a wearable video item.

The wearable item database enables storing one or more wearable video items to be used for fitting on the body item.

In some other embodiments, the video manipulation computer program is configured to maintain a wearable video item database having one or more wearable video item profiles, each of the wearable video item profiles comprising a wearable video item and a wearable video item identifier, the wearable video item identifier being specific to the wearable video item in the wearable video item profile.

The wearable item database enables storing one or more wearable video items to be used for fitting on the body item. The wearable video item profiles enable associating additional information, such as meta data and wearable video item identifiers to the wearable video item in each other wearable video item profiles.

In some embodiments, the wearable video item identifier is an identifier image item.

Accordingly, the identifier image item is an image object associated to the wearable video item in the wearable video item profile. Thus, the video manipulation computer program may be configured to add the identifier image item to the input video data or to the manipulated video data together with the fitted wearable video item for providing additional information of the fitted wearable video item or functionality relating to the fitted wearable video item.

The identifier image item may be a logo and label or the like.

In some other embodiments, the wearable video item identifier is an identifier text item.

The identifier text item is a text object associated to the wearable video item in the wearable video item profile. Thus, the video manipulation computer program may be configured to add the identifier text item to the input video data or to the manipulated video data together with the fitted wearable video item for providing additional information of the fitted wearable video item.

The identifier text item may be an information text, slogan, name, web address or the like.

In some further embodiments, the wearable video item identifier is a machine-readable optical image item.

Accordingly, the machine-readable optical image item is an image object associated to the wearable video item in the wearable video item profile. The video manipulation computer program may be configured to add the machine-readable optical image item to the input video data or to the manipulated video data together with the fitted wearable video item for functionality relating to the fitted wearable video item. The machine-readable optical image item may be scanned with a mobile device, such as camera of a mobile phone. Scanning machine-readable optical image item may configured to direct the mobile device to an internet page or provide other functionality.

In some embodiments, the video manipulation computer program is configured to add or associate the wearable video item identifier to the manipulated video data or to the input vide data.

In some other embodiments, the video manipulation computer program is configured to provide a wearable video item identifier layer comprising the wearable video item identifier, and combine the wearable video item identifier layer to the manipulated video data.

In some further embodiments, the video manipulation computer program is configured to add or associate the wearable video item identifier to the background layer, or the body item layer, or the first body part item layer or to the second body item layer.

Accordingly, the wearable video item identifier is provided to the manipulated video stream together with the wearable video item for providing information or functionality relating to the fitted wearable video item.

In some embodiments, the video manipulation computer program is configured to present the one or more wearable video item on the display of the user device, and enable a user to select one or more wearable video items to be utilized for fitting the selected wearable video item profiles.

In some other embodiments, the video manipulation computer program is configured to present the one or more wearable video item profiles on the display of the user device, and enable a user to select one or more wearable video item profiles to be utilized for fitting one or more wearable video items corresponding the selected wearable video item profiles.

The video manipulation computer program is configured present the one or more wearable video items or wearable video item profiles stored in the wearable video item database is configured to provide a virtual fitting room and configured to enable the user to select the wearable video item the user wants to be fitted on the body item or first body part item. The video manipulation computer program may be configured to enable selecting wearable video item by clicking the wearable video item on the display with a pointer of a computer mouse or touch pad or by tapping touch sensitive display.

In some embodiments, the wearable video item is a garment image item, such a shirt, skirt, trousers, jacket or the like.

In some other embodiments, the wearable video item is a clothing accessory image item, such as scarf, headwear, gloves or shoes.

In some further embodiments, the wearable video item is an eyeglasses image item, such as sunglasses or spectacles.

In yet further embodiments, the first body part item is head item and the wearable video item is a headwear image item or an eyeglasses image item.

In some other embodiments, the first body part item is a torso item and the wearable video item is a shirt image item or a jacket image item.

The wearable video item profile of each wearable video item is associated to a specific body part item. Thus, the wearable video item profile of each wearable video item comprises information to which body part item it relates. Accordingly, the video manipulation computer program is configured to fit the wearable video time on the body part item, or the first body part item, to which the wearable video item selected by the user is associated.

Further, the video manipulation computer program is configured to detect the first body part item in the input video data based on wearable video item selected by the user and fit the selected wearable video item to the first body part item based on the selected wearable video item by utilizing the information of the body part associated to the wearable body part item profile.

In some embodiments, the wearable video item is two-dimensional image item.

The two-dimensional image item may be efficiently and quickly fitted on the body item or the first body part item.

In some other embodiments, the wearable video item is a partly three-dimensional image item.

The partly three-dimensional image item may be fitted on the body item or the first body part item is a restricted positions of the body item or the first body part item in relation the imaging device. Accordingly, the person may turn and move somewhat and the wearable body item may be fitted to the body item or the first body part item during the restricted movement or turning in relation to the imaging device. This provides restricted but efficient fitting in different positions.

In some other embodiments, the wearable video item is a three-dimensional image item.

The three-dimensional image item may be fitted on the body item or the first body part item is a all positions of the body item or the first body part item in relation the imaging device. Accordingly, the person may turn and move and the wearable body item may be fitted to the body item or the first body part item during the movement or turning. This provides detailed fitting in all different positions.

In some embodiments the wearable video item provided as a unique non-fungible token.

In some other embodiments, the wearable video item is linked to a unique non-fungible token.

In further embodiments, the wearable video item is stored with a unique non-fungible token in a blockchain.

The non-fungible token makes the wearable video item unique and enables defining ownership of the wearable video item.

This may be carried out such that the wearable video item database comprises a non-fungible token wallet having one or more wearable video item profiles, each of the wearable video item profiles comprising location information of a unique non-fungible token. Each of the unique non-fungible tokens is connected to a unique wearable video item.

In some other embodiments, the video manipulation computer program is configured to access a non-fungible token wallet provided to the user device. The non-fungible token wallet having one or more wearable video item profiles, each of the wearable video item profiles comprising location information of a unique non-fungible token. Each of the unique non-fungible tokens is connected to a unique wearable video item, The video manipulation computer program may be further configured to receive location information of one or more specific non-fungible tokens from the non-fungible token wallet, and receive one or more wearable video items based on the location information.

Utilizing non-fungible tokens enables further personalizing the user or person in the video stream.

In some embodiments the video manipulation computer program is configured to add a background video item identifier to the manipulated video data, or add a background video item identifier to the background layer.

In some embodiments, the video manipulation computer program is configured to receive one or more wearable video items, and generate a wearable video item profiles for the received wearable video items, and store the generated wearable video item profiles to the wearable video item database.

Accordingly, wearable video items may be added to the video manipulation computer program.

In some other embodiments, the video manipulation computer program is configured to receive one or more wearable video items from one or more external wearable video item server systems, and generate a wearable video item profiles for the received wearable video items, and store the generated wearable video item profiles to the wearable video item database.

Accordingly, wearable video items may be added to the video manipulation computer program from external wearable video item server systems, such as online store or online image storage.

In some embodiments, the video manipulation computer program is configured to receive two or more image items of a same wearable video item, and generate the partly three-dimensional or the three-dimensional wearable video item from the received two or more image items.

Accordingly, the video manipulation computer program is configured to generate the partly three-dimensional or three-dimensional wearable video item from the two or more received two-dimensional image items representing the wearable video item from different angles or orientations.

In some other embodiments, the video manipulation computer program is configured to receive two or more image items of a same wearable video item from the one or more external wearable video item server systems, and generate the partly three-dimensional or the three-dimensional wearable video item from the received two or more image items.

Accordingly, the video manipulation computer program is configured to generate the partly three-dimensional wearable video item from the two or more two-dimensional image items representing the wearable video item from different angles or orientations and received from the external wearable video item server system.

In some embodiments, the video manipulation computer program is configured to carry out the fitting the wearable video item separately for successive image frames of the input video data.

Accordingly, the detection of the body item or the first body part item and fitting the wearable video item on the body item or the first body part item is carried out to each frame of the input video data. Thus, the fitting of the wearable video item is efficient and detailed when the person in the input video stream moves or turns.

In some embodiments, the video manipulation computer program is configured to display the manipulated video stream on a display of the user device.

Thus, the manipulated video stream may be displayed as the video stream of the imaging device.

In some other embodiments, the video manipulation computer program is configured to input the manipulated video stream to a communication computer program running in the user device.

Thus, the manipulated video stream is utilized in a separate communication computer program such as video conference computer program.

The present invention is also based on an idea of providing a video communication system, the video communication system comprising:
a video manipulation computer program comprising instructions which, when executed on at least one processor of a first user device cause the first user device to perform manipulating of an input video stream provided by an imaging device of the first user device;
a communication network configured to provide communication connection between two or more user device for data exchange between the two or more user devices; and
a communication computer program comprising instructions which, when executed on the at least one processor of the first user device cause the first user device to provide video conference connection with at least one second user device over the communication network and to exchange video data with the at least one second user device.

The manipulation computer program is configured to
capture the input video stream of the imaging device,
provide the captured input video stream as input video data to the manipulation computer program,
detect a person as a body item in the input video data, the body item representing the person in the input video data,
fit a wearable video item on the body item in the input video data to provide manipulated video data, and
output the manipulated video data as manipulated video stream from manipulation computer program; and
the communication computer program is configured to
receive the manipulated video stream, and
broadcast the manipulated video stream to the at least one second user device over the communication network.

The video manipulation computer program enables personalising the input video stream generated by the imaging device of the user device and utilize the manipulated video stream in a separate the communication computer program, such as video conference computer program.

In some embodiments, the video manipulation computer program is configured to register the manipulated video stream to an operating system of the user device as virtual imaging device, and the communication computer program is configured receive the manipulated video stream as an output video stream from the virtual imaging device.

Registering the manipulated video stream as virtual imaging device to the operating system of the user device enables any the communication computer program utilize the manipulated video stream during video communication or video conference. Thus, the manipulated video stream is not specific to any video communication computer program.

In some embodiments, the communication computer program is configured to display the manipulated video stream on a display of the user device.

In some embodiments, the at least one second user device comprises a communication computer program comprising instructions which, when executed on the at least one processor of the at least one second user device cause the at least one second user device to provide video conference connection with the first device over the communication network and to exchange video data with the first user device, the communication computer program of the at least one second user device being configured to display the manipulated video stream on a display of the at least one second user device.

Accordingly, the manipulated video stream is displayed in the display device of the at least one second user device instead of the original video stream of the imaging device of the first user device.

In preferred embodiments, the video manipulation computer program is a video manipulation program according as defined above.

An advantage of the invention is that the video manipulation computer program and the video communication system provides the user possibility to personalizes appearance of the user during video communication with other users in consistent manner. The generated manipulated video stream may be used in any communication computer program running in the user device. Therefore, manipulated video stream may be used consistently in all video communication without differences between different communication computer programs. Thus, the personalization is achieved without restrictions of the communication computer programs.

### BRIEF DESCRIPTION OF THE DRAWINGS

The invention is described in detail by means of specific embodiments with reference to the enclosed drawings, in which

FIGS. 1 to 4 show schematically structures and operation of the video manipulation computer program according to the present invention;

FIG. 5 shows schematically the video communication system according to the present invention; and

FIGS. 6 to 16 shows schematic flow charts showing the operation of the video manipulation computer program according to different embodiments of the present invention.

### DETAILED DESCRIPTION OF THE INVENTION

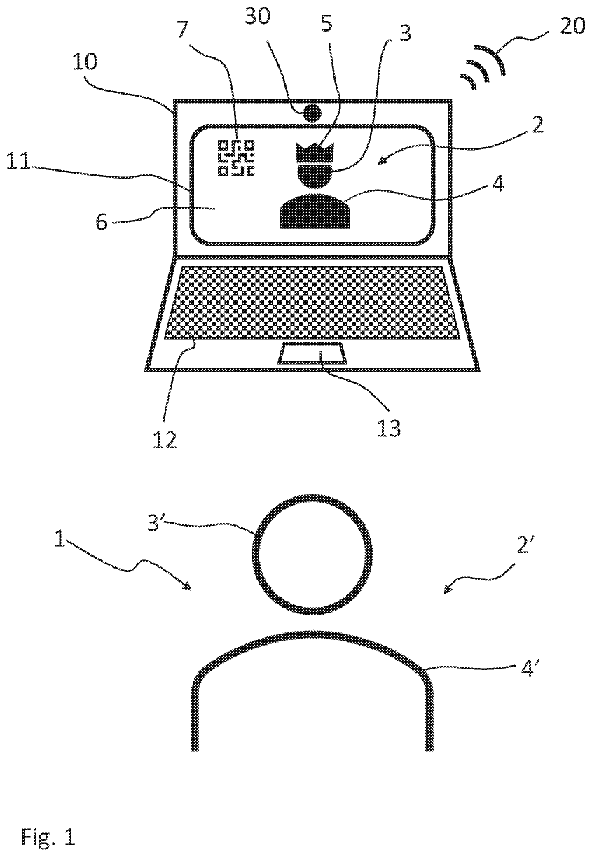

FIG. 1 shows schematically a user or person 1 using a video communication computer program in a user device 10.

The user 1 has body 2′. The body 2′ of the user 1 comprise in the FIG. 1a head 3′ and a torso 4′. The head 3′ and the torso 4′ are body parts of the body 2′ of the user 1. It should be noted that FIG. 1 schematic and it is understood the that the body 2′ of the user 1 comprises also other body parts.

The user device 10 may be a personal computer, desktop computer, laptop or user terminal, as well as a mobile communication device, such as mobile phone or a tablet computer. The user device 10 may also be personal digital assistant, thin client, electronic notebook or any other such device. Further, the user device 10 may refer to any portable or non-portable computing device. Computing devices which may be employed include wireless mobile communication devices operating with or without a subscriber identification module (SIM) in hardware or in software.

The user device 10 comprises an imaging device 30. The imaging device 30 is a digital imaging device 30 configured to generate the digital images or digital video steam.

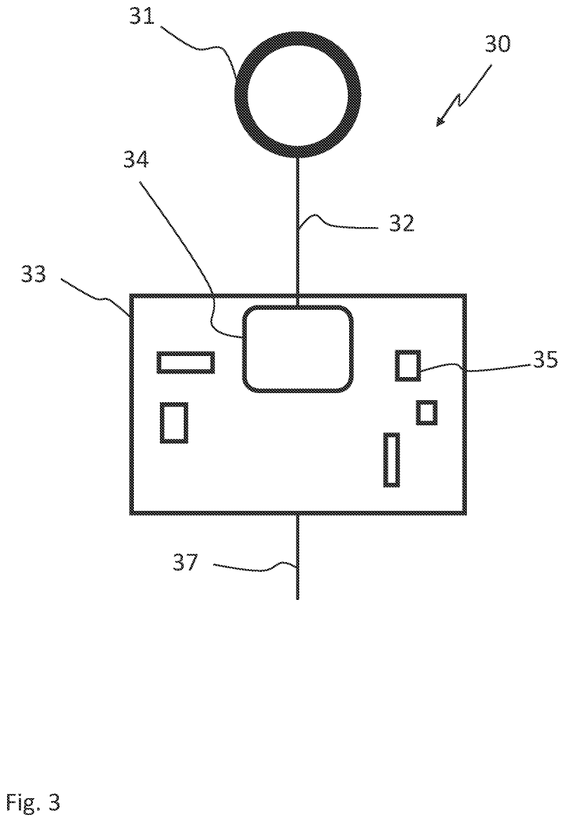

FIG. 3 shows schematically the digital imaging device 30. The imaging device 30 comprises lens 31 arranged to receive light waves, or possibly other electromagnetic radiation. The imaging device 30 further comprises arrays of electronic photodetectors in an image sensor 34 to produce images focused by a lens 31. Accordingly, the captured images are digitized. The image sensor 34 is a sensor that detects and conveys information used to produce an image by converting the variable attenuation of light waves into signals, small bursts of current that convey the information for producing the image. The waves can be light or other electromagnetic radiation. The image sensor may be for example a charge-coupled device (CCD) or an active-pixel sensor (CMOS sensor).

The lens 31 is connected to the image sensor 34 with light or waves path 32 for providing input to the image sensor 34.

The image sensor 34 arranged to an electronics element 33 of the imaging device 30. The electronics element 33 comprises a printed circuit board and support components arranged to operate the imaging device 30 and the image sensor 34.

The imaging device 30 further comprises an output arranged to output images, image data, video stream or video data from the imaging device 30 generated by the image sensor 34.

It should be noted that the present invention is not restricted to any type of imaging device 30. The imaging device 30 may be an integral imaging device of the user device 10 or it may be separate digital imaging device 30 connected to the user device 10.

The user device 10 further comprises a display 11 configured to display data, images, videos or the like. The display 11 is further configured to display images and video streams generated by the imaging device 30.

The user device 10 also comprises a communications module 20 configured to provide communication connection and/or data transfer connection with other user devices, external servers or cloud servers. The communication module 20 may comprise wireless network communication module, wherein a wireless network may be based on any mobile system, such as GSM, GPRS, LTE, 4G, 5G and beyond, and/or a wireless local area network module, such as Wi-Fi. Furthermore, the communications module 20 wired or fixed communication module. It should be noted, that the present invention is not restricted to any type of communication module 20, but any suitable communication module 20 may be used for data transfer, meaning receiving and transmitting data.

The user device 10 further comprises one or more peripheral input devices such as keyboard 12, touchpad or touch sensitive display 13, mouse or the like for operating the user device 10.

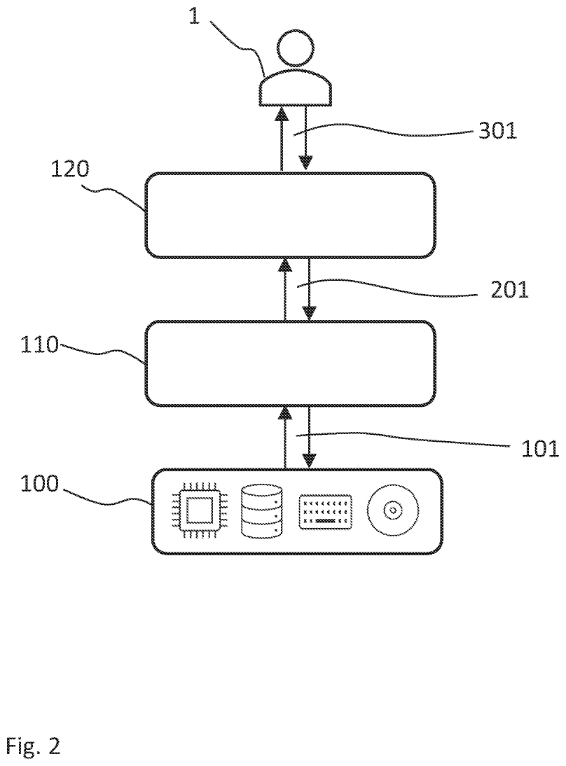

FIG. 2 shows schematically operation and internal structure of the user device 10. The user device and system thereof comprises hardware components and software components. The software components comprise application software or application computer programs 120 interacting with the user 1, as shown with arrows 301 in FIG. 2.

The hard ware components 100 comprise for example the following hardware: the processors, memory components, peripheral input devices 12, 13, display 11, communication module 20 and the imaging device 20.

The user device 1 and the system thereof further comprise an operating system 110. The operating system 110 is functionally connected to the hardware components 100 and configured to interact with and manage operations of the hardware components 100, as shown with the arrows 101 in FIG. 2. The operating system 110 is further functionally connected to the application computer programs 120 and configured interact with the application computer programs 120, as shown with arrows 201 in FIG. 2.

Accordingly, the operating system 110 is configured to control and manage interaction between the application computer programs 120 and the hardware components 100. Therefore, the operating system 110 acts as an intermediary between application computer programs 120 and the hardware 100.

Accordingly, the imaging device 30 is registered to the operating system 110 and the application computer programs 120 interact with the operating system 110 utilize the input of the imaging device 30. The application computer programs 120 are configured to utilize and receive input video stream generated by the imaging device 30 registered to the operating system 110. The operating system 110 in configured manage the input video stream of the imaging device 30 registered to the operating system 110 enabling the application computer programs to utilize and receive the input video stream generated by the imaging device 30, as indicated by the schematic FIG. 2.

The present invention provides video manipulation computer program 40 comprising instructions which, when executed on at least one processor of the user device 10 cause the user device 10 to perform manipulating of an input video stream provided by an imaging device 30 of the user device 10.

FIG. 1 shows further schematically, a user 1 in front of the imaging device 30 such that imaging device 30 is arranged to generate image data or video data including at least part of the user 1 or possible another person than the user 1. In FIG. 1 the imaging device 30 is arranged to generate image data or video data including at least part of a body of user 1. Alternatively, imaging device 30 may be arranged to generate image data or video data including whole body of the user 1 or possible another person than the user 1.

The video data generated by the imaging device comprises a body item 2 representing the body 2′ of the user 1. The body item 2′ further comprises torso item 4 representing the torso 4′ of the user 1 and a head item 3 representing the head 3′ of the user 1. The image data or video data further comprises background 6.

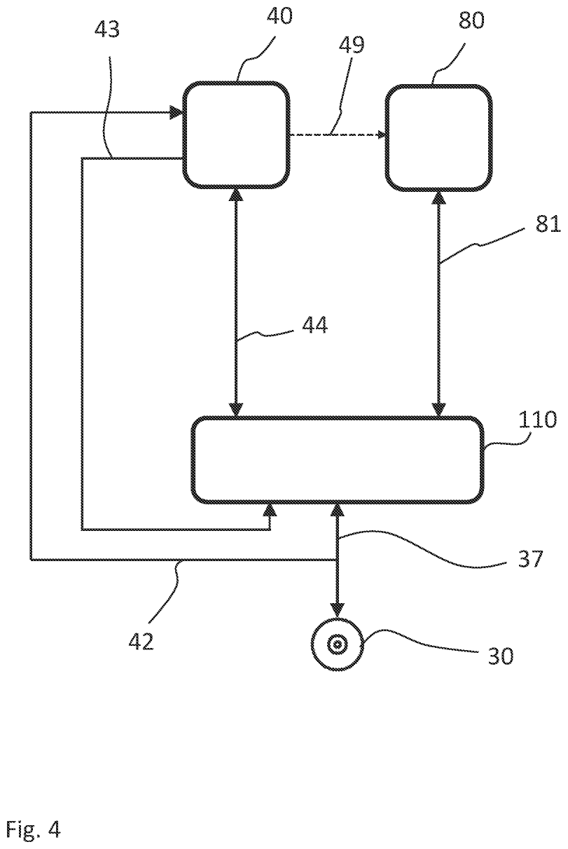

FIG. 4 shows schematically the operation of the video manipulation computer program 40 according to the present invention. The video manipulation computer program 40 is configured to capture the input video stream of the imaging device 30 from the output 37 of the 37 of the imaging device 30. The imaging device output 37 is registered to the operating system 110.

The video manipulation computer program 40 configured to capture the input video stream between the imaging device 30 and the operating system 110.

The video manipulation computer program 40 is configured to provide the captured input video stream as input video data to the manipulation computer program 40, as shown with arrow 42 in FIG. 4. The manipulation computer program 40 is further configured to detect a person 1 as a body item 2 in the input video data. The body item 2 is arranged to represent the person 1 in the input video data. The manipulation computer program 40 is configured to fit a wearable video item 5 on the detected body item 2 in the input video data to provide manipulated video data.

The manipulation computer program 40 is further configured to output the manipulated video data as manipulated video stream from the manipulation computer program 40, as shown with arrows 43 and 49 in FIG. 4.

In preferred embodiments the manipulation computer program 40 is further configured to register manipulated video stream to the operating system 110 of the user device 10 as a virtual imaging device, as shown with arrow 43 in FIG. 4. Accordingly, the manipulated video stream corresponds input video stream of the imaging device 30. The manipulated video stream registered to the operating system 110 as the virtual imaging device in configured to be other computer programs running in the user device 10 in corresponding manner as the input video stream directly from the imaging device 30.

The manipulation computer program 40 in configured to interact with the operating system 110, as shown with the arrow 44 in FIG. 4. The operating system 110 is configured to control and manage the operation of the manipulation computer program 40.

As shown in FIG. 4, the user device 10 also comprise another computer program, such as a communication computer program or video conference computer program 80.

The other computer program 80 in configured to interact with the operating system 110, as shown with the arrow 81 in FIG. 4. The operating system 110 is configured to control and manage the operation of the other computer program 40.

The other computer program 80 is configured to receive the manipulated video stream as registered to the operating system 110.

The other computer program 80 is configured to receive the manipulated video stream from or via the operating system 110, as the manipulated video stream is registered to the operating system 110 as the virtual imaging device.

Further, the other computer program 80 may be configured to enable choosing between the input video stream directly from the imaging device 30 and the manipulated video stream registered to the operating system 110 as the virtual imaging device.

In an alternative embodiment, the other computer program 80 is configured to receive the manipulated video stream directly from the video manipulation computer program 40, as show with arrow 49 in FIG. 4.

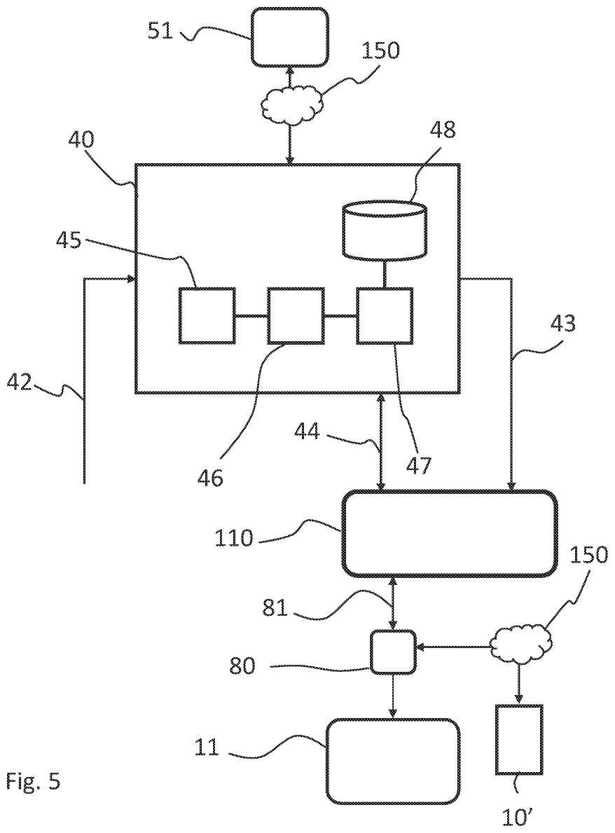

FIG. 5 shows schematically the operation of video manipulation computer program and the structure thereof as provided in the user device 10.

The user device 10 comprises a memory 46 arranged to store instructions 47 which when executed by one or more processors 45 of the user device 10 cause the video manipulation computer program 40 to perform the manipulation of the input video stream from the imaging device 30.

The video manipulation computer program 40 or the user device 10 further comprises a wearable video item database 48.

The one or more processors 45 may comprise one or more processing units or central processing units (CPU) or the like computing units. The present invention is not restricted to any kind of processors 45 or any number of processors 45.

The memory 46 may comprise non-transitory computer-readable storage medium or a computer-readable storage device. In some embodiments, the memory 46 may comprise a temporary memory, meaning that a primary purpose of memory 46 may not be long-term storage. The memory 46 may also refer to a volatile memory, meaning that memory 46 does not maintain stored contents when the memory 46 is not receiving power. Examples of volatile memories include random access memories (RAM), dynamic random access memories (DRAM), static random access memories (SRAM), and other forms of volatile memories known in the art. The memory 46 is used to store instructions of the video manipulation computer program 40 for execution by the one or more processors 45. The memory 46, in one embodiment, may be used by software (e.g., an operating system) or applications, such as a software, firmware, or middleware. The memory 46 may comprise for example operating system or software applications, the video manipulation computer program 40, comprising at least part of the instructions for executing video manipulation according to the present invention.

The wearable video item database 48 may maintain one or more wearable video item profiles, each of which wearable video item profiles comprises a wearable video item stored to the database 48 or an external network link to a wearable video item. The wearable video item database 48 may also maintain information of one or more user accounts of a plurality of users and/or information uploaded via said user accounts or user devices 10. The wearable video item database 48 may comprise one or more storage devices. The storage devices may also include one or more transitory or non-transitory computer-readable storage media and/or computer-readable storage devices. In some embodiments, storage devices may be configured to store greater amounts of information than memory 46. Storage devices may further be configured for long-term storage of information. In some examples, the storage devices comprise non-volatile storage elements. Examples of such non-volatile storage elements include magnetic hard discs, optical discs, solid-state discs, flash memories, forms of electrically programmable memories (EPROMs) or electrically erasable and programmable memories (EEPROMs), and other forms of non-volatile memories known in the art.

In one embodiment, the storage device may comprise databases and the memory 46 comprise instructions video manipulation computer program 40 for executing the video manipulation according to the present invention utilizing the processor(s) 45. However, it should be noted that the storage devices may also be omitted and the user device 10 may comprise only the memory 46, which also is configured as maintain the wearable video item database 48. Alternatively, the memory 46 could be omitted and the user device 10 could comprise only one or more storage devices. Therefore, the terms memory 46 and wearable video item database 48 could be interchangeable in embodiments which they both are not present.

The wearable video item database 48 may be provided in connection with the user device 10, as shown in FIG. 5. Alternatively, the wearable video item database 48 may be provided as an external database 48, external to the user device 10, and the wearable video item database 48 may be accessible to and connected to the user device and the video manipulation computer program directly or via a communications network 150. Accordingly, the video manipulation computer program 40 may be configured to establish data transfer connection with the external database 48 over the communication network 150.

As mentioned, the wearable video item database 48 is configured to maintain one or more wearable video item profiles, each of which wearable video item profiles comprises a wearable video item stored to the database 48 or an external network link to a wearable video item.

The video manipulation computer program 40 may be further configured to receive one or more wearable video items. The received one or more wearable video items are stored to the wearable video item database 48.

In some embodiments, the video manipulation computer program 40 is further configured to generate a wearable video item profiles for the received wearable video items and store the generated wearable video item profiles to the wearable video item database 48. The video manipulation computer program 40 is configured to store the received wearable video items 5 to the wearable video item database 48 and associate the stored wearable video items to corresponding wearable video item profiles in the wearable video item database 48.

In alternative embodiments, the video manipulation computer program 40 is further configured to receive one or more wearable video items from one or more external wearable video item server systems 51. The external server systems 51 may comprise an image bank, webstore, wearable video item database, internet page or the like external server system 51 having one or more stored wearable video items. The wearable video item database 48 may be provided in connection with the user device 10, as shown in FIG. 5. The one or more external wearable video item server systems 51 are external to the user device 10. The one or more external wearable video item server systems 51 are arranged accessible to the video manipulation computer program 40 directly or via the communication network 150. Accordingly, the video manipulation computer program 40 is configured to establish data transfer connection with the one or more external wearable video item server systems 51. Thus, the video manipulation computer program 40 is configured to receive one or more wearable video items over the communication network 150 from the one or more external wearable video item server systems 51.

Accordingly, the video manipulation computer program 40 is configured to generate a wearable video item profiles for the received wearable video items, and store the generated wearable video item profiles to the wearable video item database 48. The video manipulation computer program 40 is further configured store the received wearable video items to the wearable video item database 48 and associate the stored wearable video items to corresponding wearable video item profiles.

As shown in FIG. 5, the video manipulation computer program 40 is configured to register the manipulated video stream to the operating system 110 as the virtual imaging device, as shown with arrow 43.

The user device 10 further comprises a communication computer program 80 configured to provide video conference connection with one or more second user devices 10′ over the communication network 150.

The communication network 150 may comprise one or more wireless networks, wherein a wireless network may be based on any mobile system, such as GSM, GPRS, LTE, 4G, 5G and beyond, and a wireless local area network, such as Wi-Fi. Furthermore, the communication network 150 may comprise one or more fixed networks, wire networks or the Internet.

The communication network 150 configured to provide communication connection between two or more user device 10, 10′ for data exchange between the two or more user devices 10, 10′. The communication network 150 may be further configured to provide communication connection between the user device and the external wearable item database 48, and/or the one or more external wearable video item server systems 51.

The communication computer program 80 comprises instructions which, when executed on the at least one processor 45 of the first user device 10 cause the first user device 10 to provide video conference connection with at least one second user device 10′ over the communication network 150 and to exchange video data with the at least one second user device 10′.

The communication computer program 80 is configured receive the manipulated video stream as an output video stream from the virtual imaging device registered to the operating system 110. Accordingly, the communication computer program 80 is configured utilize the manipulated video stream registered to the operating system 110 as the virtual imaging device in the video conference session between the first user device 10 and the one or more second user device 10′.

As shown in FIG. 5, the communication computer program 80 may be further configured to display the manipulated video stream on a display 11 of the user device 10.

The communication computer program 80 is configured to broadcast or transmit the manipulated video stream from the first user device 10 to the at least one second user device 10′ over the communication network 150.

The at least one second user device 10′ is configured to receive the manipulated video stream over the communication network 150.

The at least one second user device 10′ comprises also a display and the at least one second user device 10′ is configured to display the received manipulated video stream on the display of the at least one second user device 10′.

Further, in some embodiments, the at least one second user device 10′ also comprises a communication computer program 80 comprising instructions which, when executed on the at least one processor of the at least one second user device 10′ cause the at least one second user device 10′ to provide video conference connection with the first device 10 over the communication network 150 and to exchange video data with the first user device 10.

Accordingly, the communication computer program 80 of the at least one second user device 10′ is configured to receive the manipulated video stream from the first user device 10 and from the communication computer program 80 of the first user device 10 over the communication network 150.

The communication computer program 80 of the at least one second user device 10′ is further configured to display the manipulated video stream on the display of the at least one second user device 10′.

The video manipulation computer program 40 in the first user device 10, the communication computer program 80 in the first user device 10 and the communication network are arranged to provide a video communication system according to the present invention.

The video communication system may further comprise the communication computer programs 80 in the at least one second user devices 10′.

Furthermore, video communication system may also be defined to comprise first user device 10 and the at least one second user device 10′.

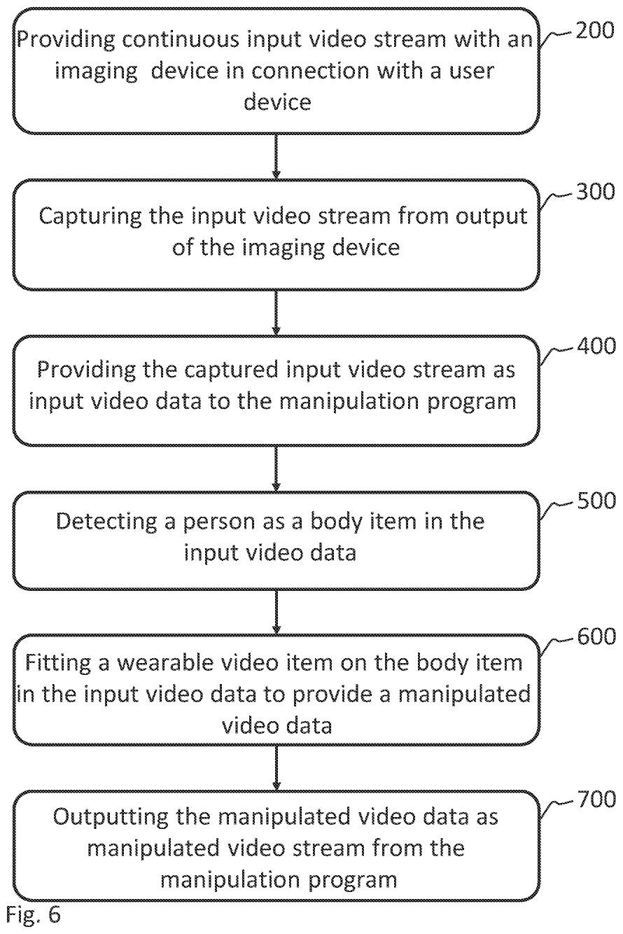

FIGS. 6 to 16 shows schematically flow charts of the operation video manipulation computer program 40.

As schematically shown in FIG. 1, the imaging device 30 of the user device 10 is configured to provide or generate a video stream in which there is a person 1 having body 2′ comprising different body parts 3′, 4′. In the generated video stream the person 1 an the body 2′ thereof is represented as the body item 2 comprising body part items 3, 4 corresponding the body parts 3′, 4′ of the body 2′ of the person 1. The video stream also comprises background 6 representing image data outside the body item 2 or outside one body part item 3, 4.

The video manipulation computer program 40 is configured fit a wearable video item 5 on the body item 2 or a first body part item 3, 4 and generate the manipulated video stream in which the wearable video item 5 is provided on the body item 2 or the first body part item 5.

The video manipulation computer program 40 may be further configured to add a wearable video item identifier 7 to the manipulated video stream.

The video manipulation computer program 40 may be configured add the wearable video item identifier 7 to the manipulated video stream together with the wearable video item 5 or separately.

The term wearable video item is an an image object representing digital image representation of an object which is worn by a person on the body of the person, on the body item 2 or the first body part item 3, 4 of the body item 2. The wearable video item 5 may be garment, hat, eyeglasses, scarf, shirt, jacket, trousers, skirt, or shoes or the like wearable video item 5 which is fitted on the body item 2 or the body part item 3, 4 in the input video data.

The wearable image item 5 may be two-dimensional or three-dimensional image item or object.

The wearable video item may also be provided as a unique non-fungible token.

Accordingly, the wearable video item 5 may be linked to a unique non-fungible token, or the wearable video item 5 may be stored with a unique non-fungible token in a blockchain.

In the exemplary embodiment of FIG. 1, the first body part item 3 is the head item of the body item 2 representing the head 3′ of the body 2′ of the person 1. Further, the wearable video item 5 is a hat fitted on the head item 3 in the manipulated video stream.

FIG. 6 shows schematically operation of the video manipulation computer program 40 according to the present invention.

The imaging device 30 of the user device 10 is configured to provide or generate a continuous video stream in step 200. The video manipulation computer program 40 is configured to capture the generated input video stream from the output of the imaging device 30 or from the imaging device 30 in step 300. The video manipulation computer program 40 is further configured to provide the captured input video stream as input video data to the manipulation computer program 40 in step 400.

The video manipulation computer program 40 is further configured to detect the person 1 as a body item 2 in the input video data, step 500. The body item 2 represents the person 1 in the input video data. The video manipulation computer program 40 is then configured to fit the wearable video item 5 on the body item 2 in the input video data to provide or generate manipulated video data in step 600.

Accordingly, the video manipulation computer program 40 is configured to generate the manipulated video data by fitting the wearable video item 5 on the body item 2 in the input video data.

The video manipulation computer program 40 is further configured to output the manipulated video data as manipulated video stream from the manipulation computer program 40. Thus, the output of the video manipulation computer program 40 the manipulated video stream. The video manipulation computer program 40 is configured to continuously and also in generally real-time generate manipulated video stream from the input video stream of the imaging device 30.

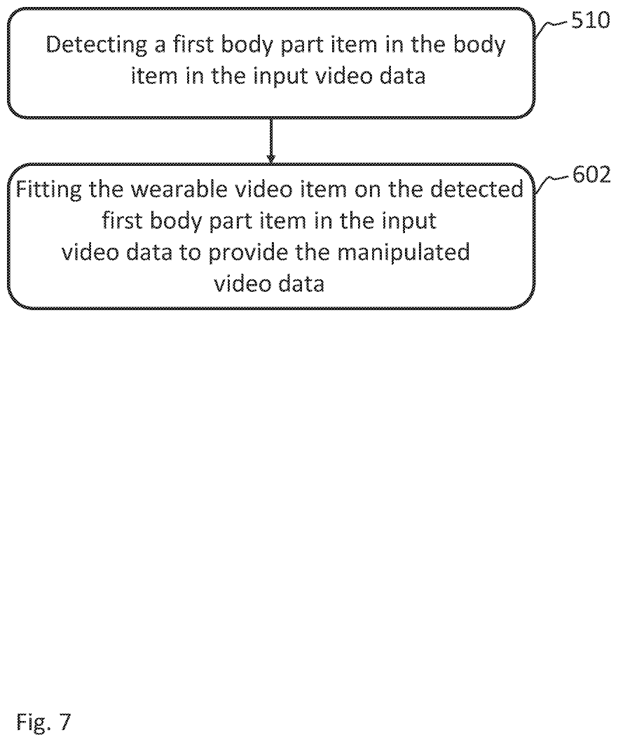

FIG. 7 discloses one embodiment in which the video manipulation computer program 40 is configured to identify a first body part item 3 in the input video data or in the detected body item 2 in the input video data in step 510. The first body part item 3 representing one body part 3′ of the person 1. The video manipulation computer program 40 is further configured to fit the wearable video item 5 on the identified first body item 3 in the input video data to provide the manipulated video data in step 602.

In FIG. 1 the first body part item 3 represents the head 3′ of the person 1. The wearable video item 5 is a hat fitted to the first body part item 3 representing the head 3′ of the person 1.

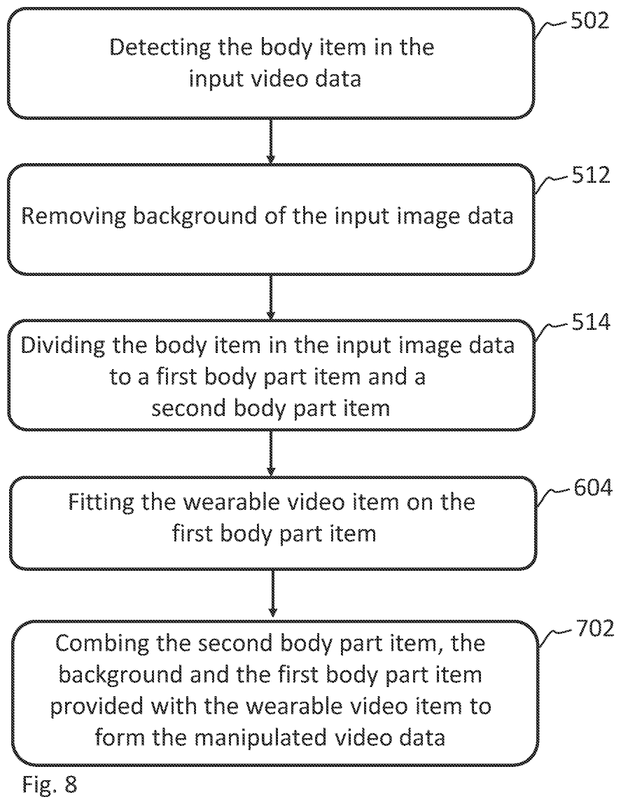

FIG. 8 discloses an embodiment in which the wearable video item 5 is fitted on the first body part item 3 in the input video data.

The video manipulation computer program 40 is configured to detect the body item 2 in the input video data in step 502.

The video manipulation computer program 40 is then configured to remove background or background image item 6 from the input video data in step 512. The background image item 6 comprises image data outside the detected body item 2. The background is removed based on the detected body item 2 in the input video data.

The video manipulation computer program 40 is then configured to divide the detected body item to a first body item 3 and to a second body item 4 in step 514.

In the embodiment of FIG. 1, the video manipulation computer program 40 is configured to divide the body item 2 into first body item 3, meaning the head item, and to the second body item 4, meaning the torso item n step 514.

The video manipulation computer program 40 is then configured to fit the wearable video item 5 on the first body part item 3 in step 604.

The video manipulation computer program 40 is further configured to combine the first body part item 3 having the wearable video item 5 and the second body part item 4. Accordingly, the body item 2 is formed by combining the first and second body part items 3, 4. Then video manipulation computer program 40 is further configured to combine the removed background item 6 with the body item 2 in which the first body part item 3 is provided with the wearable video item 5 to generate the manipulated video data, as defined in step 702.

Alternatively, the video manipulation computer program 40 is configured to combine the first body part item 3 having the wearable video item 5, the second body part item 4, and the removed background item 6 to generate the manipulated video data, as defined in step 702.

In some embodiments, in the step 514 the video manipulation computer program 40 is configured to split the input video data into a body item layer and a background layer. The body item layer comprises the detected body item 2 and the background layer comprises the background item 6 and thus image data outside the detected body item 2. The video manipulation computer program 40 is further configured to split input video data or the body item layer into a first body part item layer and a second body item layer. The first body item layer comprising the identified first body part item 3 and the second body item layer comprising body item 4 outside the identified first body part item 4.

Then, the video manipulation computer program 40 is configured to fit the wearable video item 5 on the identified first body part item 3 in the first body part item layer in step 604.

Further, the video manipulation computer program 40 is configured to combine first body part item layer, the second body item layer and the background layer to generate the manipulated video data having the wearable video item 5 on the first body part item 3, as defined in step 702.

In some embodiment, the video manipulation computer program 40 is configured to generate a wearable video item layer comprising the wearable video item 5. The video manipulation computer program 40 is then configured to fit the wearable video item 5 on the body item 2 or the first body part item 3 by fitting the wearable video item layer on the body item layer or the first body part item layer such that the wearable video item 5 on the body item 2 or on the first body part item 3. This is carried out in step 604.

Then the video manipulation computer program 40 is configured to combine the body item layer, the wearable video item layer and the background layer to generate the manipulated video data. Alternatively, the video manipulation computer program 40 is configured to combine the first body part item layer, the wearable video item layer, the second body part item layer and the background layer to generate the manipulated video data.

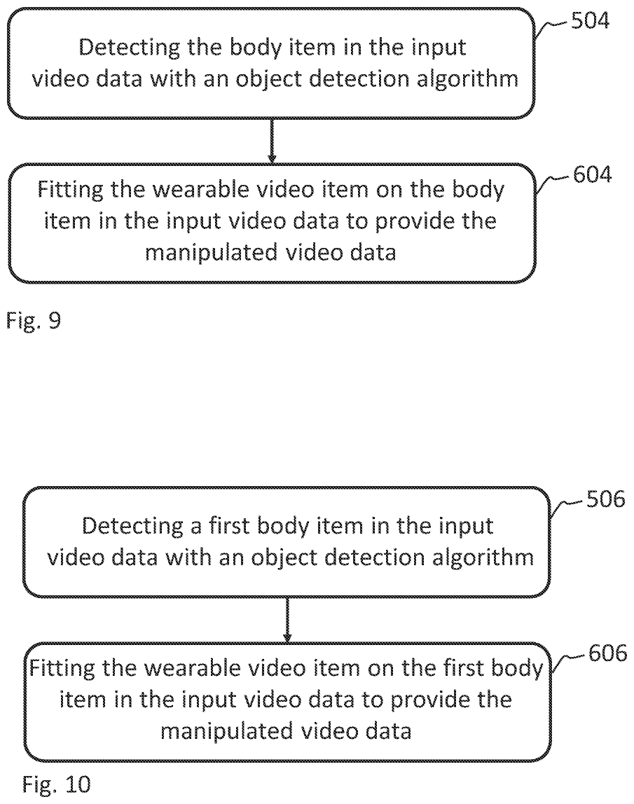

In alternative embodiments as shown in FIG. 9, the video manipulation computer program 40 is configured to provide an object detection algorithm trained to detect body item in image data. The video manipulation computer program 40 is further configured to utilize the input video data as input data into the object detection algorithm for detecting the body item 2 in the input video data in step 504, and fit the wearable video item 5 on the detected body item 2 in the input video data to provide the manipulated video data having the wearable video item 5 on the body item 2 in step 604. Accordingly, utilizing the object detection algorithm there is no need split or divide the input video data and the fitting may be carried out based on the detection by the object detection algorithm.

FIG. 10 shows an alternative embodiment, in which the video manipulation computer program 40 is configured to provide an object detection algorithm trained to detect body item in image data and identify one or more body part items in the detected body item or detect and identify the first body part item directly from the input video data in step. The video manipulation computer program 40 is further configured to utilize the input video data as input data into the object detection algorithm for identifying the first body part item 3 in the input video data in step 506, and fit the wearable video item 5 on the identified first body part item 3 in the input video data to provide the manipulated video data having the wearable video item 5 on the first body part item 3, as shown in step 606.

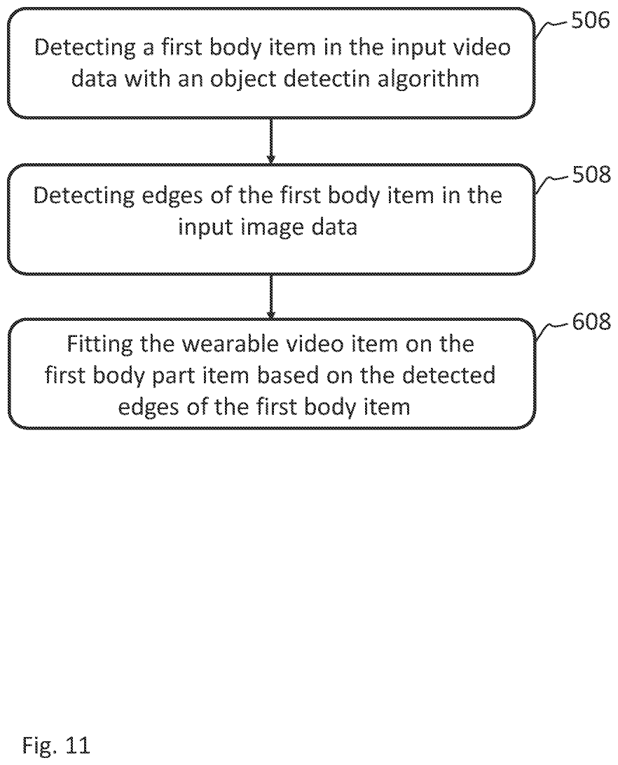

FIG. 11 discloses the preferable embodiments in which the object detection algorithm is used. In this embodiment, the object detection algorithm in configured to detect edges of the first body part item 3 in the input image data in step 508. The video manipulation computer program 40 is further configured to fit the wearable video item 5 on the first body part item 3 based on the detected edges of the first body part item 3, in step 608. Accordingly, the detected edges of the first body part item 3 are utilized to fit the wearable video item 5 on the first body part item in detail.

Similarly, the object detection algorithm could be configured to detect edges of the body item 2 and the video manipulation computer program 40 to fit the wearable video item 5 on the body item 2 based on the detected edges of the body item 2.

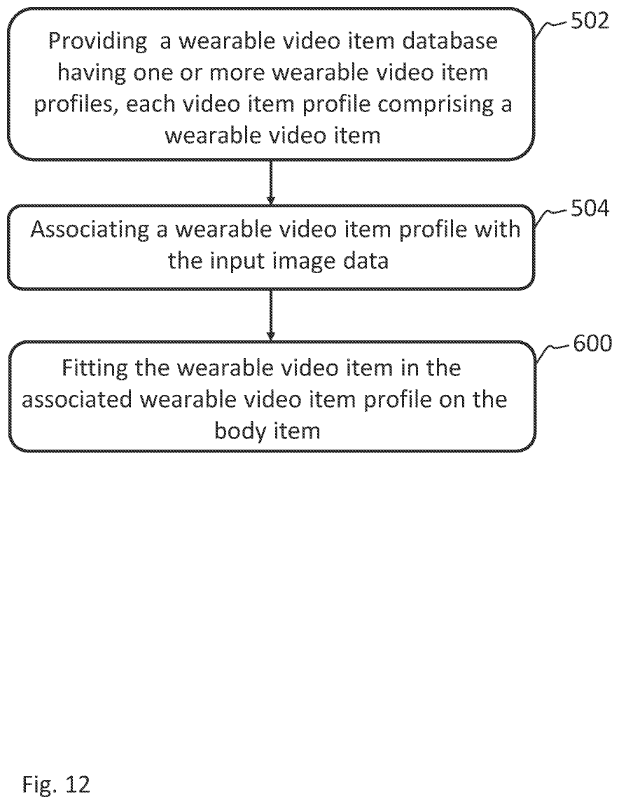

FIG. 12 discloses schematically proving the wearable video item database 48.

The video manipulation computer program 40 is configured to maintain or provide the wearable video item database 48 having one or more wearable video item profiles, as indicated in step 502. Each of the wearable video item profiles comprising a wearable video item 5. The video manipulation computer program 40 is further configured to associate a wearable video item profile with the input video data, as shown in step 504. Associating the wearable video item profile with the inputvideo data may be carried out based on selection by the user.

Then in step 600, the wearable video item 5 of the associated wearable video item profile is fitted on the body item 2 or on the first body part item 3.

FIG. 1 discloses embodiments 800, in which the video manipulation computer program 40 is configured to receive one or more wearable video items 5 in step 802, and generate a wearable video item profiles for the received wearable video items 5 in step 804, and further store the generated wearable video item 5 and associate the store wearable video item 5 to the generated wearable video item profile in step 806.

The wearable video item profile is generated to the wearable video item database 48 and the wearable video item 5 is further stored to the wearable video item database 48.

In step 802, the one or more wearable video items may be received from one or more external wearable video item server systems 51.

Instead of step 804, the wearable video item database 48 may comprise ready-made wearable video item profile with which the received wearable video item 5 is associated.

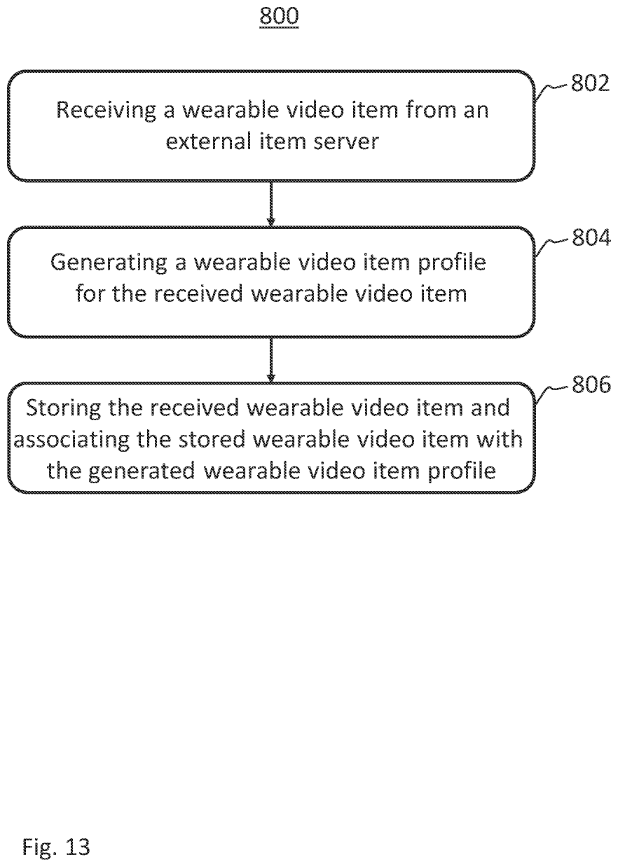

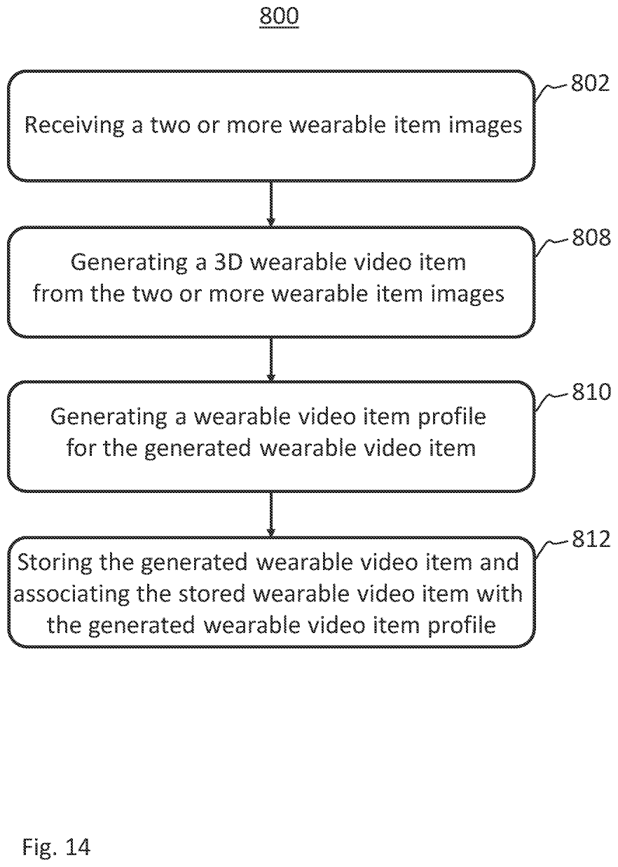

FIG. 14 shows a modification of embodiment of FIG. 13. The video manipulation computer program 40 is configured to receive two or more image items representing same wearable video item 5, in step 802. The video manipulation computer program 40 is configured to generate the partly three-dimensional or the three-dimensional wearable video item 5 from the received two or more image items, in step 808.

The video manipulation computer program 40 may be further configured to generate a wearable video item profiles for the generated wearable partly three-dimension or three-dimensional video item 5 in step 810, and further store the generated wearable video item 5 and associate the store partly three-dimension or three-dimensional video wearable video item 5 to the generated wearable video item profile in step 812.

It should be noted, that in some embodiments generating the wearable video item profile may be omitted and the received or generated wearable video items stored directly to the wearable video item database 48. In this case, an item identifier may be provided and associated with the stored wearable video item 5.

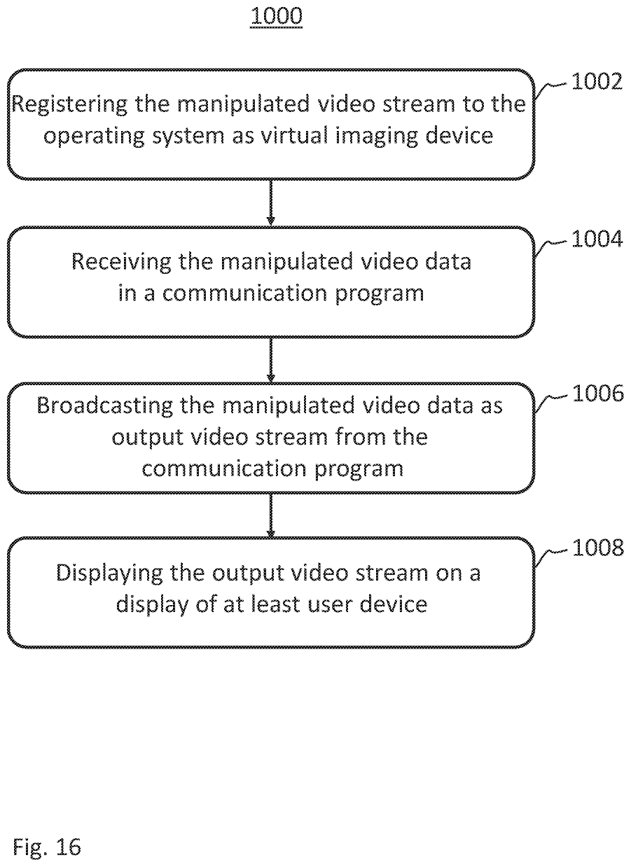

FIG. 16 discloses an embodiment 900, which a wearable video item identifier 7 in associated to the wearable video item 5 or wearable video item profile.

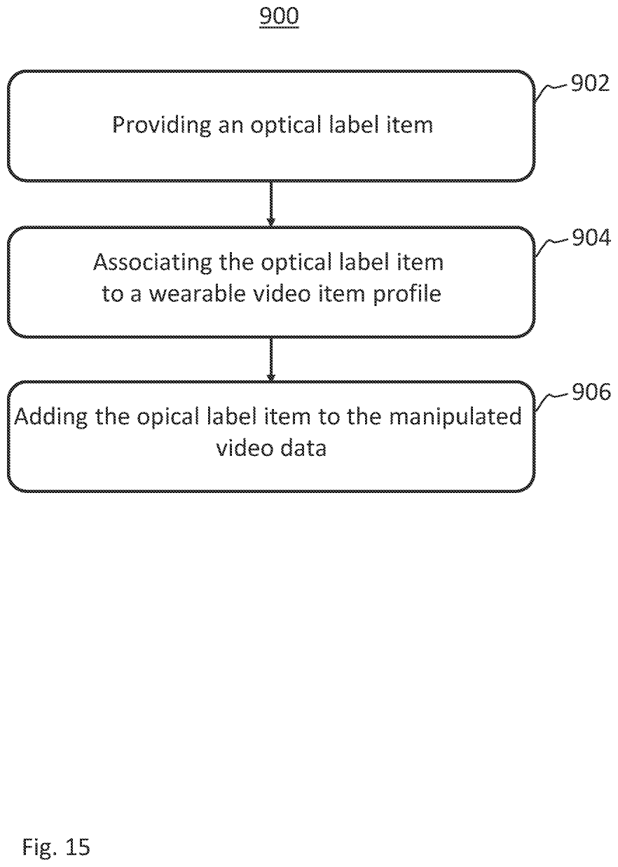

The video manipulation computer program 40 is configured to provide the wearable video item identifier in step 902, which in embodiment of FIG. 15 is an optical label item, meaning a machine-readable optical image item 7.

The machine-readable optical image item 7 may be QR-code or barcode or the like. Accordingly, another user of a second user device 10′ may scan the machine-readable optical image item 7 with a camera of a mobile phone or the like scanning device to receive information of the wearable video item 5 in the manipulated video stream during a video conference. The information in the machine-readable optical image item 7 may also be a link to an internet page or address.

The video manipulation computer program 40 is configured to associate the wearable video item identifier 7 to the wearable video item 5 or wearable video item profile, as disclosed in step 904.

The video manipulation computer program 40 is further configured to add the wearable video item identifier 7 to the input video data or to the manipulated video instep 906. Thus the manipulated video stream outputted from the video manipulation computer program 40 comprises the wearable video item 5 and the wearable video item identifier 7.

In some embodiments, the video manipulation computer program 40 is configured to add the wearable video item identifier 7 to the background item layer, or the body item layer, or the first body part item layer, or the second body part item layer.

In some alternative embodiments, the video manipulation computer program 40 is configured to add the wearable video item identifier 7 to the wearable video item layer.

Further, in some other embodiments the video manipulation computer program 40 is configured to generate a wearable video item identifier layer comprising the wearable video item identifier 7.

Then the video manipulation computer program 40 is configured to combine the wearable video item identifier layer with other layers or with the input video data to generate the manipulated video data.

Operations in the video communication system are disclosed in FIG. 16. The video manipulation computer program 40 is configured to output the manipulated video stream and register the manipulated video stream t the operating system 110 of the user device 10 as virtual imaging device in step 1002.

The communication computer program 80 is configured to receive the manipulated video stream as an output video stream from the virtual imaging device, in step 1004. The communication computer program 80 is further configured to broadcast or transmit the manipulated video stream to the at least one second user device 10′ over the communication network 150 in step 1006.

The communication computer program 80 of the at least one second user device 10′ is further configured to display the manipulated video stream on a display of the at least one second user device 10′ in step 1008.

The invention has been described above with reference to the examples shown in the figures. However, the invention is in no way restricted to the above examples but may vary within the scope of the claims.

1.-24. (canceled)

25. A video manipulation computer program comprising instructions which, when executed on at least one processor of user device cause the user device to perform manipulating of an input video stream provided by an imaging device of the user device, wherein the video manipulation computer program being configured to:
capture the input video stream of the imaging device;
provide the captured input video stream as input video data to the manipulation computer program;
detect a person as a body item in the input video data, the body item representing the person in the input video data;
fit a wearable video item on the body item in the input video data to provide manipulated video data; and
output the manipulated video data as manipulated video stream from the manipulation computer program.

26. The video manipulation computer program according to claim 25, wherein the video manipulation computer program is further configured to:
register the manipulated video stream to an operating system of the user device as virtual imaging device.

27. The video manipulation computer program according to claim 25, wherein:
the imaging device comprises an image sensor configured to generate the input video stream, and
the manipulation computer program is configured to capture input video stream generated by the image sensor; or
the imaging device comprises an image sensor configured to generate the input video stream, and to provide the input video stream to the output of the imaging device, and
the manipulation computer program is configured to capture input video stream from the output of the imaging device.

28. The video manipulation computer program according to claim 25, wherein the video manipulation computer program is further configured to:
identify a first body part item in the detected body item in the input video data, the first body part item representing one body part of the person; and
fit the wearable video item on the identified first body item in the input video data to provide the manipulated video data.

29. The video manipulation computer program according to claim 25, wherein the video manipulation computer program is further configured to:
remove background image item from the input video data, the background image item comprising image data outside the body item,
fit the wearable video item on the detected body item, and
combine the removed background image item and the body item having the wearable video item to provide the manipulated video data having the wearable video item on the body item; or
remove background image item from the input video data, the background image item comprising image data outside the identified first body part item,
fit the wearable video item on the identified first body item, and
combine the removed background image item and the first body part item having the wearable video item to provide the manipulated video data having the wearable video item on the first body part item; or
remove background image item from the input video data, the background image item comprising image data outside the body item,
separating the first body part item from the body item,
fit the wearable video item on the separated first body part item,
combine the first body part item to the body item, and
combine the removed background image item and the body item having the wearable video item to provide the manipulated video data having the wearable video item on the first body part item.

30. The video manipulation computer program according to claim 29, wherein the video manipulation computer program is further configured to:
split the input video data into a body item layer and a background layer, the body part layer comprising the detected body item and the background layer comprising image data outside the detected body item,
fit the wearable video item on the detected body item in the body item layer, and
combine the background layer and the body item layer to provide the manipulated video data having the wearable video item on the body item; or
split the input video data into a first body part item layer and a background layer, the first body part item layer comprising the identified first body part item and the background layer comprising image data outside the identified first body part item,
fit the wearable video item on the identified first body item in the first body part item layer,
combine the background layer and the first body part item layer to provide the manipulated video data having the wearable video item on the first body part item; or
split the input video data into a body item layer and a background layer, the body item layer comprising the detected body item and the background layer comprising image data outside the detected body item,
split the body item layer into a first body part item layer and a second body item layer, the first body item layer comprising the identified first body part item and the second body item layer comprising body item outside the identified first body part item,
fit the wearable video item on the identified first body part item (3) in the first body part item layer, and
combine first body part item layer, the second body item layer and the background layer to provide the manipulated video data having the wearable video item on the first body part item.

31. The video manipulation computer program according to claim 25, wherein the video manipulation computer program is further configured to:
maintain a wearable video item database having one or more wearable video item profiles, each of the wearable video item profiles comprising a wearable video item; or
maintain a wearable video item database having one or more wearable video item profiles, each of the wearable video item profiles comprising a wearable video item and a wearable video item identifier, the wearable video item identifier being specific to the wearable video item in the wearable video item profile.

32. The video manipulation computer program according to claim 31, wherein:
the wearable video item identifier is an identifier image item; or
the wearable video item identifier is an identifier text item; or
the wearable video item identifier is a machine-readable optical image item.

33. The video manipulation computer program according to claim 31, wherein the video manipulation computer program is further configured to:
add the wearable video item identifier to the manipulated video data; or
provide a wearable video item identifier layer comprising the wearable video item identifier; and
combine the wearable video item identifier layer to the manipulated video data.

34. The video manipulation computer program according to claim 25, wherein:
the wearable video item is a garment image item; or
the wearable video item is a clothing accessory image item; or
the wearable video item is an eyeglasses image item; or
the first body part item is head item and the wearable video item is a headwear image item or an eyeglasses image item; or
the first body part item is a torso item and the wearable video item is a shirt image item or a jacket image item.

35. The video manipulation computer program according to claim 34, wherein:
the wearable video item is two-dimensional image item; or
the wearable video item is a partly three-dimensional image item; or
the wearable video item is a three-dimensional image item.

36. The video manipulation computer program according to claim 25, wherein the video manipulation computer program is further configured to carry out the fitting the wearable video item separately for successive image frames of the input video data.

37. The video manipulation computer program according to claim 25, wherein the video manipulation computer program is further configured to:
display the manipulated video stream on a display of the user device; or
input the manipulated video stream to a communication computer program running in the user device.

38. A video communication system, the video communication system comprising:
a video manipulation computer program comprising instructions which, when executed on at least one processor of a first user device cause the first user device to perform manipulating of an input video stream provided by an imaging device of the first user device;
a communication network configured to provide communication connection between two or more user device for data exchange between the two or more user devices; and
a communication computer program comprising instructions which, when executed on the at least one processor of the first user device cause the first user device to provide video conference connection with at least one second user device over the communication network and to exchange video data with the at least one second user device, wherein:
the manipulation computer program being configured to:
capture the input video stream of the imaging device,
provide the captured input video stream as input video data to the manipulation computer program,
detect a person as a body item in the input video data, the body item representing the person in the input video data,
fit a wearable video item on the body item in the input video data to provide manipulated video data, and
output the manipulated video data as manipulated video stream from manipulation computer program;
the communication computer program being configured to:
receive the manipulated video stream, and
broadcast the manipulated video stream to the at least one second user device over the communication network.

39. The video communication system according claim 38, wherein:
the video manipulation computer program is configured to register the manipulated video stream to an operating system of the user device as virtual imaging device, and
the communication computer program is configured receive the manipulated video stream as an output video stream from the virtual imaging device.
